(19) United States
(12) Patent Application Publication
(10) Pub. No.: US 2023/0169829 A9
(43) Pub. Date: Jun. 1, 2023

(54) SYSTEM, METHOD, AND GAMING MACHINE FOR DYNAMICALLY INCREASING NUMBER OF PAYLINES OF REEL-BASED WAGERING GAMES

(71) Applicant: Cyrus Luciano, Reno, NV (US)

(72) Inventor: Cyrus Luciano, Reno, NV (US)

(21) Appl. No.: 17/511,364

(22) Filed: Oct. 26, 2021

Related U.S. Application Data
(60) Provisional application No. 63/233,168, filed on Aug. 13, 2021.
(60) Provisional application No. 63/231,026, filed on Aug. 9, 2021.

(51) Int. Cl. G07F 17/32; G07F 17/34

(52) U.S. Cl. CPC G07F 17/3267; G07F 17/3213; G07F 17/34

(57) ABSTRACT

A system, method, and gaming machine dynamically increases a number of paylines in a reel-based wagering game is provided. The system, method, and gaming machine provides a gaming device having a game display configured to display at least a portion of game reels of the reel-based wagering game, a controller programed to display, on the game display, a plurality of game reels and a multiplier reel, wherein the controller dynamically increases the number of paylines per stop on the game reels on a given spin of the game reels by the multiplier reel.

### CROSS-REFERENCE TO RELATED APPLICATION(S)

This application claims priority to and the benefit of U.S. Provisional Patent Application Ser. No. 63/231,026, filed Aug. 9, 2021, and U.S. Provisional Patent Application Ser. No. 63/233,168, filed Aug. 13, 2021 both disclosures of which are hereby incorporated by reference in their entirety for all purposes.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### BACKGROUND OF THE INVENTION

It is known to provide slot games with a reel set having multiple reels and paylines. In a typical slot game, there are multiple paylines to allow a player to have multiple chances to win. As with multi-way games, the number of paylines in the slot game is typically fixed. For example, there are five (5) payline games, twenty-five (25) payline games, fifty (50) payline games, and so on. In some slot games, the reels may expand or reveal, and additional paylines may consequently be added which cover the expanded or revealed portions of the reels in the reel set. The present invention is directed to dynamically increasing the number of paylines in a slot game without changing a size of the reels.

### SUMMARY OF THE INVENTION

The present invention provides a system, method, and gaming machine to dynamically increase a number of paylines in a slot game during play on a given spin without touching a reel set, stops, or symbols on reels of the reel set.

The present invention also provides a system, method, and gaming machine for dynamically increasing a number of paylines in a reel-based wagering game including a gaming device having a game display configured to display at least a portion of game reels of the reel-based wagering game, a controller programed to display, on the game display, a plurality of game reels and a multiplier reel and the controller dynamically increases the number of paylines per stop on the game reels on a given spin of the game reels by the multiplier reel.

One advantage of the present invention is that the system, method, and gaming machine may be applied to payline games such as reel-based wagering games having multiple reels and paylines. Another advantage of the present invention is that the system, method, and gaming machine dynamically increase the number of paylines of a reel-based wagering game without changing the size of the reels or dynamically increasing the number of paylines in play on a given spin without touching the reel set, stops, or symbols on the reels. Yet another advantage of the present invention is that the system, method, and gaming machine modifies the overall volatility of the game with a multiplier reel while allowing the overall game experience to remain satisfactory

Other features and advantages of the invention will be readily appreciated as the same becomes better understood by reference to the following detailed description when considered in connection with the accompanying drawings.

### BRIEF DESCRIPTION OF THE DRAWINGS

FIG. 1 is a schematic representation of a system for dynamically increasing a number of paylines in a slot game illustrated on a gaming machine, according to an embodiment of the present invention.

FIG. 2 is an exemplary view of a reel set that may be used with the system shown in FIG. 1.

FIG. 3 is an exemplary view of a multiplier reel that may be used with the reel set of FIG. 2 for a slot game, according to an embodiment of the present invention.

FIG. 4 is an exemplary view of a multiplier reel and reels of a reel set for the slot game that may be used with the system shown in FIG. 1.

FIG. 5 is an exemplary view of a multiplier reel and reels of a reel set for the slot game that may be used with the system shown in FIG. 1, according to an embodiment of the present invention.

### DETAILED DESCRIPTION OF THE PREFERRED EMBODIMENT(S)

The exemplary embodiments herein relate to various systems and methods used in gaming applications. It should be understood that each of the methods and individual steps recited herein may be partially or wholly carried out in a variety of ways and/or systems, which may include, but are not limited to, an electronic gaming machine (“EGM”) or slot machine for use by one or more players, a multiplayer platform which may include a player interface such as a touchscreen display and involve physical or virtual game symbols, a home computer and/or portable computing device, such as a tablet computer or mobile phone capable of communicating with a network or over the Internet, global telecommunication network or world wide web.

It should further be understood that the present invention is directed to, among other things, methods of providing, conducting and resolving wagering games that include a sequence of controlled and concrete events. Some of these events may involve communications between computing components, establishing the eligibility of such computing components based on location and game specific rules, indication preferences, placing wagers, debiting and awarding credits stored in an account, the generation or interpretation of random data and results for one or more players, the application of randomly-generated data to predefined rules, the determination of wager outcomes in accordance with preset outcome determining criteria, and the notification of such outcomes. The generation of random data may be facilitated by computerized and/or physical implements, such as a random number generator (“RNG”) or credits/chips awarded.

A selected embodiment of the present invention will now be explained with reference to the drawings. It will be apparent to those skilled in the art from this disclosure that the following description of the embodiment of the present invention is provided for illustration only and not for the purpose of limiting the present invention as defined by the appended claims and their equivalents.

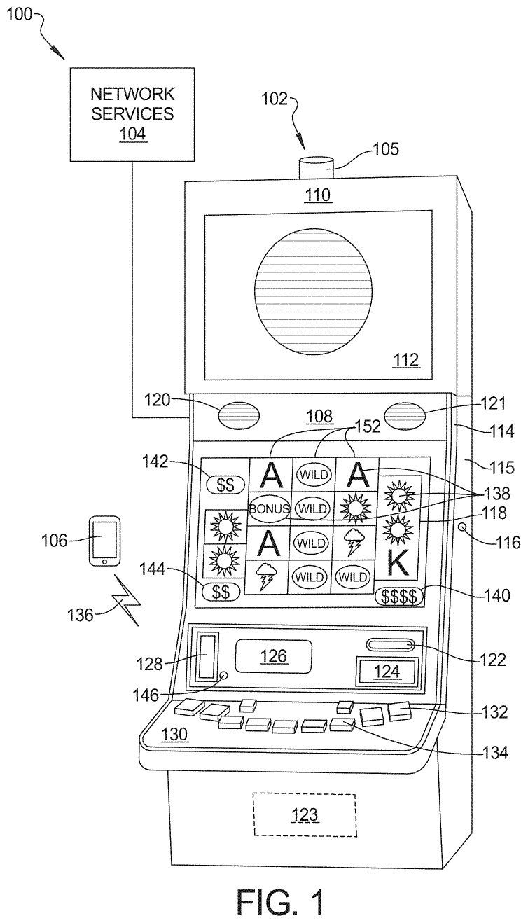

In general, gaming systems which provide wager-based games are described. In particular, with respect to FIG. 1, a gaming system 100 includes a wager-based gaming machine 102 such as a slot machine. The wager-based gaming machine 102 may include wireless or wired communication interfaces which allow communications with remote devices providing network services 104, such as, but not limited to, a player tracking system or a progressive gaming system. The player tracking system can be part of a slot accounting system. In addition, the gaming machine 102 may include wireless communication interfaces, such as wireless interface 146, which allow communications with a nearby mobile device, such as a mobile phone 106 or tablet computer, via a wireless connection 136. It should be appreciated that the wireless interface 146 may employ wireless communication protocols, such as Bluetooth™ or Wi-Fi.

The mobile phone 106 or tablet computer can be utilized by a player or casino operator. A device carried by a player can be configured to perform gaming related functions, such as functions associated with transferring funds to or from the gaming machine 102 or functions related to player tracking. A device carried by a casino operator can be configured to perform operator related functions, such as performing hand pays, responding to tilt conditions or collecting metering related information.

The gaming machine 102 may include a cabinet 108 and a top box 110. The top box 110 is mounted above the cabinet 108. The top box 110 includes a display 112. The display 112 may be used to display video content, such as game art associated with the game played on the gaming machine 102. For example, the game art can include an animated wheel. The animated wheel can be configured to spin and to stop to reveal a bonus award. In other examples, the video content can include advertising and promotions.

In other embodiments, the top box 110 may include one or more mechanical devices in addition to the display or in lieu of the display. For example, a mechanical device, such as a mechanical wheel can be mounted to or within the top box 110. The mechanical wheel can include markings that indicate various bonus awards. The wheel can be spun and stopped at a particular stopping point to reveal a bonus award. In yet other embodiments, the top box 110 may include a plurality of displays.

The cabinet 108 may include an entry door 114. In one embodiment, the door 114 swings outward and is coupled to a back portion 115. The door 114 includes a locking mechanism 116. During operation, the door 114 is locked. Typically, unlocking the door 116 causes the gaming machine 108 to enter a tilt mode where gaming functions, such as the play of a wager-based game, are not available. It should be appreciated that this tilt mode can be referred to as a hard tilt.

The cabinet 108 may include a number of apertures that allow access to a portion of a number of devices which are mounted to the cabinet 108. These gaming devices can include, but are not limited to a display 118, speaker 120, speaker 121, a printer 122, a bill acceptor 124, a secondary display 126, a card reader 128 and a button panel 130 including buttons 132 and 134. It should be appreciated that these gaming devices can be used to generate wager-based game play on the gaming machine 102.

In particular embodiments, the bill acceptor 124 may be used to accept currency or a printed ticket which can be used to deposit credits on the gaming machine 102. The credits may be used for wagers. The printer 122 can be used to print tickets to transfer credits from the gaming machine 102. Typically, the tickets may be redeemed for cash or additional game play, such as game play on another gaming machine.

The bill acceptor 124 and printer 122 printer may be part of ticket-in/ticket-out (TITO) system (not shown) The TITO system may be included in the network services. The TITO system allows a ticket printed at a first gaming machine with a credit amount to be inserted into a bill acceptor at a second gaming machine and validated for game play. After validation, the credit amount associated with the ticket can be made available for game play on the second gaming machine.

The bill acceptor 124 may include a slot surround by a bezel which allows banknotes of various denominations or printed tickets to be inserted into the bill acceptor. The bill acceptor 124 may include sensors for reading information from the banknotes and determining whether the banknotes inserted through the slot are valid. Banknotes determined to be invalid, such as damaged or counterfeit notes, can be ejected from the bill acceptor 124. In some instances, the bill acceptor 124 may include upgradeable firmware and a network connection. It should be appreciated that via the network connection, new firmware, such as new counterfeit detection algorithms can be downloaded to the bill acceptor 124.

The bill acceptor 124 includes mechanisms for guiding the banknotes or printed tickets past the internal sensors. Banknotes or printed tickets which are accepted can be guided to a bill stacker (not shown) located within the cabinet 108 of the gaming machine 102. It should be appreciated that the bill stacker can hold a maximum number of bank notes or printed tickets, such as up to two thousand.

The gaming machine 102 may include a sensor for detecting a fill level of the bill stacker. When the bill stacker is full or close to being full, the gaming machine 102 can be placed in a tilt mode. Next, the cabinet door 114 can be opened and the full bill stacker can be replaced with an empty one. Then, the door 114 can be closed and the gaming machine 102 can be restored to an operational mode in which it is available for game play.

One function of the printer 122 is to print “cash out” tickets. In a “cash out,” credits available on the gaming machine 102 may be transferred to an instrument, such as a printed ticket, or electronically transferred to an account for later access. Typically, a “cash out” can be initiated in response to pressing one of the physical buttons, such as 132 or 134, or touch screen button output on a display, such as display 118.

In one embodiment, the printer 122 may be a thermal printer. The printer can be loaded with a stack of tickets, such as a stack with two hundred, three hundred or four hundred tickets. Mechanisms in the printer 122 can grab tickets from the ticket stack and transport the tickets past the print heads for printing. It should be appreciated that the ticket stack may be located in an interior of the cabinet 108.

The printer 122 can include sensors for detecting paper jams and a status of the ticket stack. When a paper jam or low ticket stack is detected, the gaming machine 102 can enter a tilt mode where game play is suspended. In one embodiment, a tower light 105 can light to indicate the tilt status of the gaming machine 102. After the tilt condition is cleared, such as by clearing the paper jam or replenishing the ticket stack, the gaming machine 102 can enter an operational mode where game play is again available.

In particular embodiments, the printer 122 can be coupled to a gaming machine controller 123. The gaming machine controller 123 can be configured to send commands to the printer which cause a “cash out,” ticket to be generated. In addition, the printer 122 can be coupled to other systems, such as a player tracking system (not shown). When coupled to the player tracking system, commands may be sent to the printer 122 to output printed tickets redeemable for comps (comps refer to complimentary awards, such as but not limited to free credits, a free drink, a free meal or a free room) or printed coupons redeemable for discounts on goods and services.

In additional embodiments, a wireless interface 146 can be provided to generate the wireless connection 136. The wireless connection 136 may be established between the gaming machine 102 and the mobile device 106. The wireless connection 136 can be used to provide functions, such as, but not limited to, player tracking services, casino services (e.g., ordering drinks) and enhanced gaming features (e.g., displaying game play information on the mobile device). The wireless interface can be provided as a stand-alone unit or can be integrated into one of the devices, such as the bill/ticket acceptor 122 and the card reader 128. In addition, the bill/ticket acceptor 122 and the card reader 128 can each have separate wireless interfaces for interacting with the mobile device. In one embodiment, these wireless interfaces can be used with a wireless payment system, such as Apple Pay™ or Google Pay™. It should be appreciated that the wireless payment system can be used to transfer funds to the gaming machine that can be used for wager-based game play.

The door 114 can allow access an interior of the cabinet 108. Via this access, devices mounted to the cabinet, such as display 118, speaker 120, bill/ticket acceptor 122 or printer 124 can be serviced and maintained. For example, a receptor configured to receive currency and tickets, coupled to the bill acceptor, can be emptied. The receptor is often referred to as a bill stacker. In another example, blank tickets can be added to the printer 122 or paper jams can be cleared from the printer. When door 114 is opened, the gaming machine 102 can enter a hard tilt state where game play is disabled.

In addition, a number of devices (not shown) can be provided within the interior of the cabinet 108. A portion of these devices is not visible through an aperture in the cabinet 108. For example, a gaming machine controller (GMC) 123 which controls play of a wager-based game on the gaming machine may be found within the cabinet 108. It should be appreciated that the gaming machine controller 123 is typically secured within a separate lockable enclosure (not shown).

As another example, a number of security sensors can be placed within the interior of the cabinet 108. The security sensors (not shown) can be configured to detect access to the interior of the gaming machine 102 For example, the sensors can be configured to detect when the locking mechanism 106 is actuated, the door 116 is opened or a locking mechanism associated with the gaming machine controller enclosure is actuated. It should be appreciated that a power source, separate from an external power supply, such as a battery can be provided which allows the security sensors to operate and be monitored when the external power supply is not connected.

In particular embodiments, the cabinet 108 can have a sheet metal exterior designed to provide the rigidity needed to support top boxes and light kits as well as to provide a serious deterrent to forced entry. For example, the sheet metal can be sixteen gauge steel sheet. Additionally, the door, such as 114, can be backed with sheet steel in the areas around the displays. It should be appreciated that other materials, such as wood, wood composites, can be incorporated into the cabinet 108 and the example of sheet metal is provided for the purposes of illustration only.

A speaker, such as 120 or 121, can be protected by a metal screen. In one embodiment, the speaker 120 or 121 can be a subwoofer speaker. In general, a sound system associated with the gaming machine 102 can include an audio amplifier and one or more speakers of various types, such as subwoofers, midrange speakers and tweeters.

The displays 118, 112, and 126, the speakers 120 and 121, the printer 122, the bill acceptor 124, the card reader 128 and the button panel 130 can be used to generate a play of a wager-based game on the gaming machine 102. Further, the display 118 can include a touchscreen. The touchscreen can be used to provide inputs used to play the wager-based game. Some examples of wager-based games that can be played include but are not limited to slot games, card games, bingo games and lottery games. The wager-based games are typically games of chance and utilize a random number generator to determine an outcome to the game.

In general, the wager-based games can be classified as Class II and Class III games. Class II games can include bingo, pull tabs, lottery, punch board, tip jars, instant bingo and other bingo like games. Class III games can include but are not limited to slot games, black jack, craps, poker and roulette.

As described above, the wager-based game may be a slot game. The play of the slot game can involve receiving a wager amount and initiating a start of the wager-based game. A selection of a wager amount and a start of the wager-based game can be performed using buttons, such as 132 and 134, on the button panel 130. In addition, the button panel can be used to perform gaming functions, such as selecting a number of paylines to play in the slot game, selecting the amount to wager per line, initiating a cash-out, and calling an attendant. It should be appreciated that these functions will vary for different types of games.

The play of wager-based game, such as a slot game, can involve making a wager and then generating and outputting a game presentation. The bet amount can be indicated in 142. The game presentation can include a number of game features that vary from game to game. The game features provide variety in how the outcome to the wager-based is presented. For example, an award to the outcome of the game can be presented in a series of steps that vary from game to game. In some instances, a portion of the total award for a game can be awarded in each step. The steps and their graphical presentation can be referred to as game features. In various embodiments, information associated with one or more of the steps can be stored to a power hit tolerant memory.

As an example, a portion of a slot game outcome presentation is shown on the display 118. The slot game outcome presentation can include displaying a plurality of symbols, such as 138. During the game outcome presentation, the symbols 138 can appear to move on reels 152 of a reel set on the display 118. The gaming machine controller 123 includes a Random Number Generator to generate the symbols 138 on reels 152 of a reel set. It should be appreciated that the symbols 138 can move off the display 118 and new symbols 138 can appear on the display 118.

Different combinations of symbols can appear on the display 118 for some period of time, which varies for each instance of the wager-based game that is played. At the end of the presentation, the symbols 138 reach a final position and an award associated with the game outcome is presented on the display 118. The total award for the game can be indicated in 144 and the total credits available on the gaming machine 102 after the award can be indicated in 140.

The gaming system 100 may include reel-based wagering games 150 and corresponding game methods. The reel-based wagering games 150 additionally or alternatively may be referred to as slots, video slots, slot games, slot machines, reel-based slot machines, and so forth. The reel-based wagering games 150 may include any number of reels 152 in a reel set, with any number of symbols 154 associated with the reels 152. The presentation, representation, or display of the reel-based wagering game 150 may be described as including a grid 156 of symbol positions 157, including two or more rows 158 and two or more columns 160, with individual columns 160 corresponding to individual reels 152, and with the displayed symbols 154 shown in the symbol positions 157 representing a subset of the total symbols 154 associated with all of the reels 152. The reels 152 may be displayed as stopped reels, with only a subset of symbols 154 associated with a given reel 152 being displayed. Additionally, the reels 152 may be displayed as changing reels, with the symbols 154 associated with a given reel 152 moving, such as in connection with a spinning reel in mechanical examples, or simply as changing symbols, whether simulating a mechanical reel or representing random or other representation of symbols.

In mechanical examples, the game reels 152 may include physical reel strips where the symbols 154 are shown in images fixed on the reel strips. Virtual reel strips may be mapped to these physical reel positions shown on the reel strips to expand the range or diversity of game outcomes. In video slot examples, reel strips may be encoded in a memory or database, and virtual reels may be used for the game reels 152 with images representing the data related to the reel strips. In other slot machine embodiments, each symbol position 157 on the grid 156 may be associated with an independent reel strip. In yet other slot machine embodiments, reels and/or reel strips may not be used at all in determining the symbols 154 shown in the symbol positions 157 of the grid 156. For example, the symbol 154 may be randomly selected for each symbol position 157 within the grid 156, or the symbols 154 may be determined in part by game events occurring during game play, such as displayed elements in the symbol positions 157 being replaced by new game elements or symbols. It should be appreciated that numerous variations are possible for implementing slot-type game play.

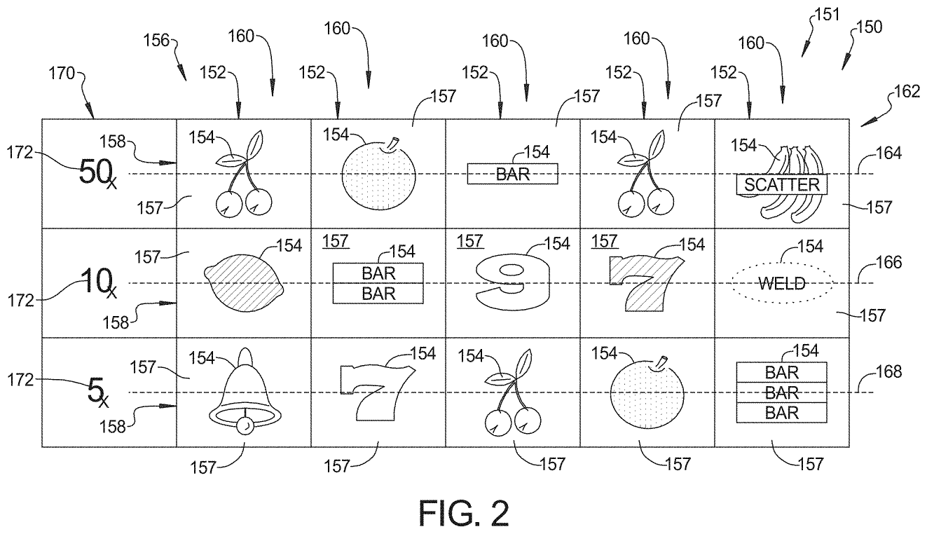

The example reel-based wagering games 150 illustrated in FIGS. 2-5 have a grid 156 representing three rows of symbols 154 from five reels 152, resulting in a total of fifteen displayed symbols 154 when all five reels 152 are stopped, and are referred to herein as games 151. It should be appreciated, however, the features of example games 151 discussed herein may be applied to reel-based wagering games 150 having any size of grid 156 with any number and configuration of paylines 162.

Payout schemes associated with slots may include evaluations of symbol combinations associated with paylines, scatter pays, multi-way pays, or other types of symbol combination evaluation methods. In payline based slot games, payout schemes are often associated with one or more paylines 162, where each payline 162 corresponds to a predetermined arrangement or combination associated with predetermined symbol positions 157 within a game's grid 156. To ascertain whether a payout condition exists for a given game outcome, the symbols 154 within the symbol positions 157 associated with a particular payline 162 may be evaluated to determine if a symbol combination is present that matches an entry in a paytable with an associated award. Any number of paylines 162 may be utilized in the reel-based wagering game 150, according to the present invention, and for simplicity, games 151 shown in FIG. 2 have three paylines 162. More specifically, with respect to example games 151, one payline 164 is associated with the upper row 158 of the symbols 154, one payline 166 is associated with the middle row 158 of the symbols 14, and one payline 168 is associated with the lower row 158 of the symbols 154.

Although embodiments of the reel-based wagering games 150 that utilize paylines 162 as part of their payout schemes are described, other embodiments may use different payout schemes while still benefitting from the concepts described herein. For example, in embodiments where the reel-based wagering game 150 utilizes multi-way payout schemes, similar principles of beginning the symbol combination evaluations at different starting points among the respective game reels 152 may be used.

With the above as a framework, some of the reel-based wagering games 150 may be described as comprising X game reels 152, where X is an integer greater than or equal to three (3). Thus, for example with respect to the example game 151 illustrated in FIG. 2, X equals five. The reel-based wagering games 150 also may be described as comprising multiple paylines 162, with each payline associated with a distinct number of the symbol positions 157 of the game symbols 154 when the game reels 152 are stopped. In some reel-based wagering games 150, the different payout schemes may be triggered based on the number of matching or predetermined arrangement of game symbols aligned along a distinct payline 162, for example, with a first set of matching or predetermined arrangement of game symbols resulting in a higher payout than a second set having fewer matching or predetermined arrangement of game symbols than the first set.

Historically, most reel-based wagering games 150 evaluate symbol combinations starting at the left-most game reel and then proceeding to the right (“left to right paying games”), although other games may evaluate symbol combinations beginning on the right-most reel and then proceeding to the left (“right to left paying games”) or evaluate both left to right and right to left (“both way paying games”). For left to right paying game embodiments, the games generally only payout if the left-most stopped reel has at least one symbol that initiates or begins a symbol combination associated with an award in a paytable. Accordingly, after the second left-most reel stops, if no symbols of the second left-most stopped reel match or correspond to symbols on the left-most game reel along a payline (or within the entire left-most game reel for a multi-way pay evaluation game embodiment), then no payouts from the payline (or multi-way pay) evaluations can occur, and a player may lose interest in the game. This may be particularly true with games having five, six, or more total reels, because the player must wait for the rest of the game reels to stop to start a new play, even though no payout from the paylines (or multi-way pays) has already been determined.

For simplicity and when referring to example game 151, a win, or payout, condition results when three or more identical symbols are aligned in sequence along the payline 162. It should be appreciated that, as understood in the art of reel-based games, other predetermined arrangements of symbols, including arrangements of more or less identical symbols, or combinations using non-identical symbols, may result in a win condition of the reel-based wagering game 150.

The present invention improves on top of the traditional multi-way evaluation of a video reel-based wagering game 150 or slot game in which symbol wins are determined by the symbols 154 landing in adjacent reels, either left-to-right, right-to-left, and so on. In a typical multi-way game, the number of “ways” is usually fixed and determined by the number of reels and the number of stops per reel. As such, a 3×5 reel game has two-hundred forty-three (243) ways, a 4×5 reel game has one thousand twenty-four (1024) ways, etc. In some reel-based wagering games 150, the reels 152 may expand or reveal, in which case the number of ways may be increased.

The present invention allows the number of ways to increase without change the size of the reels 152—but to instead allow more paylines per stop in each reel 152. Thus, a reel-based wagering game 150 with five (5) reels and three (3) stops per reel 152, two-hundred forty-three (243) ways, may on a given spin change to three (3) stops on the first reel 152, six (6) stops on the second reel 152, five (5) stops on the third reel 152, seven (7) stops on the fourth reels 152, and three (3) stops on the fifth reel 152—in which case, the player is treated to a reel-based wagering game 150 playing at 1,890 ways on that given spin. As a result, any multi-way reel-based wagering game 150 may be adapted to play as a “megaways” game as disclosed in U.S. Patent Application Publication No. 2021/0241570 without shrinking or revealing smaller game symbols. It should be appreciated that the present invention can be used in the extremely popular i-Gaming and land-based applications as well.

In one embodiment, for example, on a given spin, each payline 162 can be evaluated as any number of paylines 162. In one embodiment of the present invention, the gaming machine 102 includes a multiplier reel 170 displaying a multiplier 172 at each stop on the left-hand side of the display 118 to visually represent the number of paylines 162. The multiplier reel 170 is similar to the reels 152 and may be displayed as a stopped reel, with only a subset of the multipliers 172 associated with the multiplier reel 170 being displayed. Additionally, the multiplier reel 170 may be displayed as a changing reel, with the multipliers 172 associated with the multiplier reel 170 moving, such as in connection with a spinning reel in mechanical examples, or simply as changing multipliers 172, whether simulating a mechanical reel or representing random or other representation of the multipliers 172. It should be appreciated that the multiplier reel 170 is driven by the Random Number Generator of the gaming machine controller 123 to generate the multipliers at each stop of the reel 152. It should also be appreciated that the present invention modifies the overall volatility of the game with the multiplier reel 170 while allowing the overall game experience to remain satisfactory.

In one embodiment, for example, a 3×5, fifty (50) line game 151, is being played with ten (10) lines beginning at each of the three (3) stops on the first reel 152. For example, on a given spin, the multiplier reel 170 may display the multiplier 172 of 10× next to stop 1, 50× next to stop 2, and 5× next to stop 3 as illustrated in FIG. 2. Consequently, all ten (10) paylines 162 beginning at stop 1 can be evaluated as ten (10) paylines 162 each—effectively increasing the number of paylines 162 beginning at stop 1 from ten (10) to one hundred (100); all ten (10) paylines 162 beginning at stop 2 will be evaluated as fifty (50) paylines 162 each—effectively increasing the number of paylines (162) beginning at stop 2 from ten (10) to five hundred (500); and all ten (10) paylines 162 beginning at stop 3 will be evaluated as five (5) paylines 162 each—effectively increasing the number of paylines 162 beginning at stop 3 from ten (10) to fifty (50). It should be appreciated that, on this theoretical spin in the example, the reel-based wagering game 150 has increased from a ten (10) payline game 151 to a six-hundred fifty (650) line game 151.

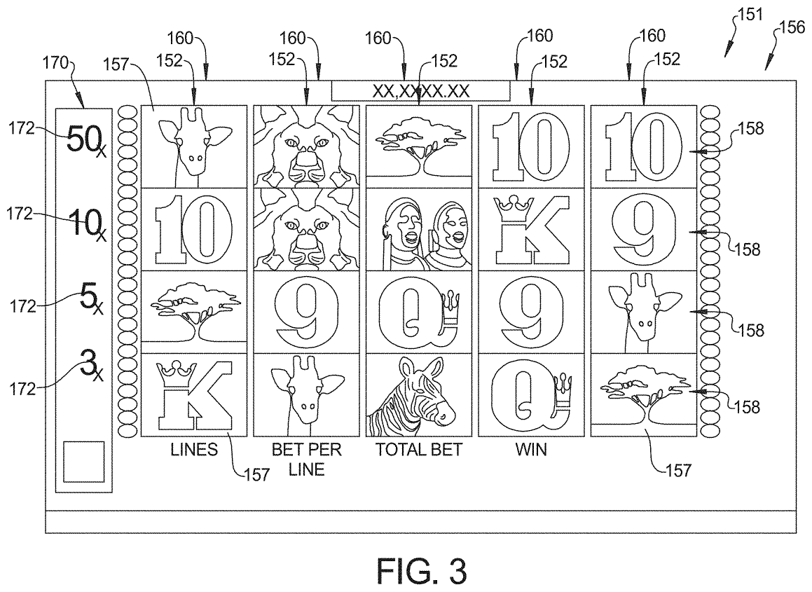

In another embedment, for example, a 4×5, fifty (50) line reel-based wagering game 150, is being played with fifty (50) lines beginning at each of the four (4) stops on the first reel 152. For example, on a given spin, the multiplier reel 170 may display the multiplier 172 of 10× next to stop 1, 50× next to stop 2, 5× next to stop 3, and 3× net to stop 4 as illustrated in FIG. 3. Consequently, all fifty (50) paylines 162 beginning at stop 1 can be evaluated as ten (10) paylines 162 each—effectively increasing the number of paylines 162 beginning at stop 1 from fifty (50) to five hundred (500); all fifty (50) paylines 162 beginning at stop 2 will be evaluated as fifty (50) paylines 162 each—effectively increasing the number of paylines (162) beginning at stop 2 from fifty (50) to two thousand five hundred (2,500); all fifty (50) paylines 162 beginning at stop 3 will be evaluated as five (5) paylines 162 each—effectively increasing the number of paylines 162 beginning at stop 3 from fifty (50) to two hundred fifty (250); and all fifty (50) paylines 162 beginning at stop 4 will be evaluated as three (5) paylines 162 each—effectively increasing the number of paylines 162 beginning at stop 4 from fifty (50) to one hundred fifty (150). It should be appreciated that, on this theoretical spin in the example, the reel-based wagering game 150 has increased from a fifty (50) payline game 151 to a three thousand four hundred fifty (2,650) line game 151.

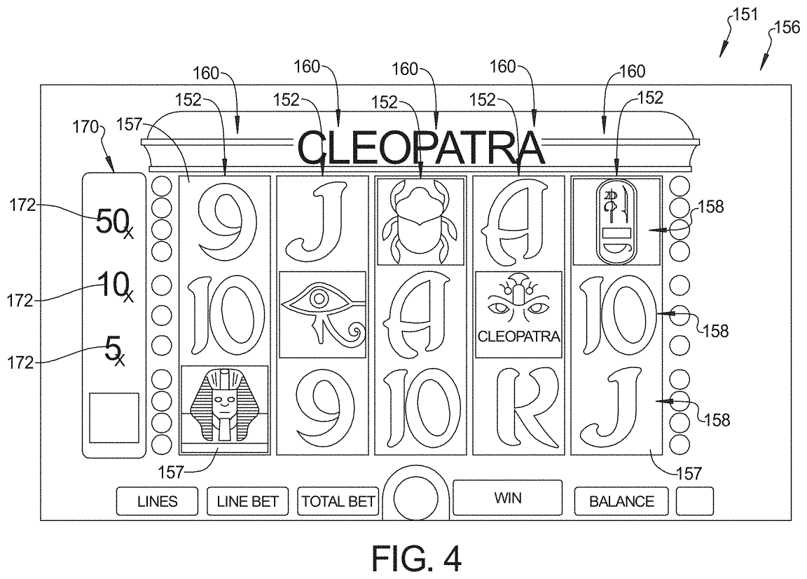

In yet another embedment, for example, a 3×5, twenty (20) line game 151, is being played with twenty (20) lines beginning at each of the three (3) stops on the first reel 152. For example, on a given spin, the multiplier reel 170 may display the multiplier 172 of 10× next to stop 1, 50× next to stop 2, and 5× next to stop 3 as illustrated in FIG. 4. Consequently, all twenty (20) paylines 162 beginning at stop 1 can be evaluated as twenty (20) paylines 162 each—effectively increasing the number of paylines 162 beginning at stop 1 from twenty (20) to two hundred (200); all twenty (20) paylines 162 beginning at stop 2 will be evaluated as fifty (50) paylines 162 each—effectively increasing the number of paylines (162) beginning at stop 2 from twenty (20) to one thousand (1,000); and all twenty (20) paylines 162 beginning at stop 3 will be evaluated as five (5) paylines 162 each—effectively increasing the number of paylines 162 beginning at stop 3 from twenty (20) to one hundred (100). It should be appreciated that, on this theoretical spin in the example, the reel-based wagering game 150 has increased from a twenty (20) payline game 151 to a one thousand three hundred fifty (1,300) line game 151.

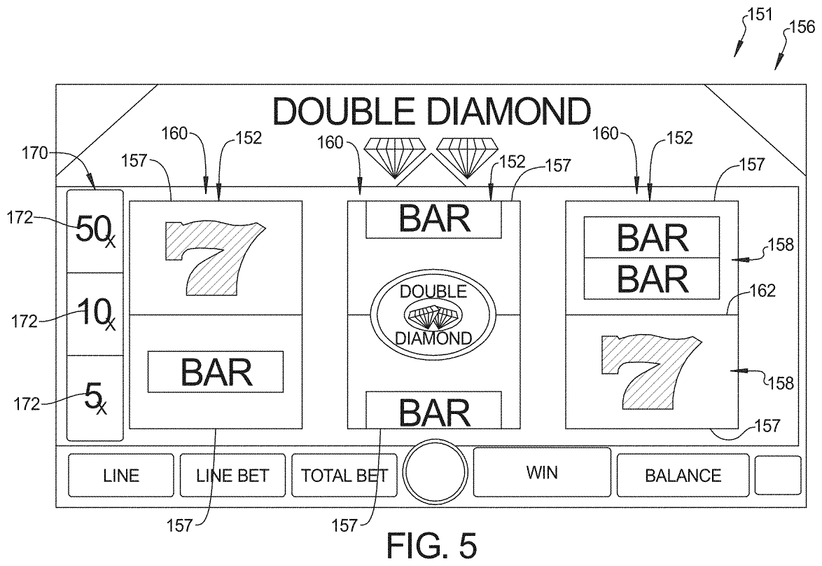

In still another embodiment For example, a 2×3, one (1) line game 151, is being played with one (1) line beginning at each of the three (3) stops on the first reel 152. For example, on a given spin, the multiplier reel 170 may display the multiplier 172 of 10× next to stop 1, 50× next to stop 2, and 5× next to stop 3 as illustrated in FIG. 5. Consequently, the one (1) payline 162 beginning at stop 1 can be evaluated as one (1) payline 162 each—effectively increasing the number of paylines 162 beginning at stop 1 from one (1) to ten (10); one (1) payline 162 beginning at stop 2 will be evaluated as fifty (50) paylines 162 each—effectively increasing the number of paylines (162) beginning at stop 2 from one (1) to fifty (50); and one (1) payline 162 beginning at stop 3 will be evaluated as five (5) paylines 162 each—effectively increasing the number of paylines 162 beginning at stop 3 from one (1) to five (5). It should be appreciated that, on this theoretical spin in the example, the reel-based wagering game 150 has increased from a one (1) payline game 151 to a sixty-five (65) line game 151.

Using the present invention, any payline reel-based wagering game 150 may be adapted to be a megaways game retaining the look and structure of the original reel-based wagering game 150, but with the added excitement and potential of dynamically increasing the paylines 162 on a given spin. It should be appreciated that the present invention maximizes the player experience and excitement of this feature.

The gaming machine controller 123 includes a processor, a memory device for storing program code or other data; a display as described above; and one or more input device interfaces. The gaming machine 102 may further include a sound output system having a sound card, speakers, headphone jack, and other means to drive sound output, one or more video cards configured to drive at least one display 118, and additional display units.

The processor is typically a microprocessor or microcontroller-based platform which is capable of displaying images on the display 118 of game symbols, creating and representationally displaying a game grid and game grid elements and various other components of the game. The memory device can include random access memory (RAM) for storing event data or other data generated or used during a particular game. The memory device can also include read only memory (ROM), or other non-transitory computer-readable media configured to store program code which controls the gaming machine 102 so it plays a particular game in accordance with applicable game rules and pay tables.

It should be appreciated that although a processor and memory devices are possible implementations, further embodiments can also be implemented using one or more application-specific integrated circuits (ASIC's) or other hard-wired devices, or using mechanical devices (collectively, and/or individually referred herein as a “processor”). Furthermore, although the processor and memory device in certain embodiments reside on each gaming machine 102, it is possible to provide some or all of their functions from an off-site device such as a network server for communication to a playing station such as over a local area network (LAN), wide area network (WAN), Internet connection, microwave link, and the like. The processor and memory device are generally referred to as a “computer” or “controller.”

Input devices, can include physical buttons and controllers such as joysticks, mice, keyboards, and similar game controllers. Further, an input device can include specialized devices such as a currency acceptor configured to relay the input of value to the processor. Examples can include devices that: take in bills or coins, read credit cards, take contactless payments, or any other means of taking an item of worth and conveying the value of the worth to the processor. Physical buttons may be symbolically represented on a display device configured to display input information. The display device may further be configured to directly accept input from a user, as in a touch screen device or infrared screen overlay device. In further embodiments, additional value data may be obtained from a networked device configured to obtain value data and provide it to a processor.

This written description uses examples to disclose the aspects of the present invention, including the best mode, and also to enable any person skilled in the art to practice the invention, including making and using any devices or systems and performing any incorporated methods.

Those skilled in the art will readily appreciate that the systems and methods described herein may be a standalone system or incorporated in an existing gaming system. The system of the present invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the present invention so long as players and operators thereof are provided with useful access thereto, either through a mobile device, gaming platform, or other computing platform via a local network or global telecommunication network.

Although specific features of various embodiments of the present invention may be shown in some drawings and not in others, this is for convenience only. In accordance with the principles of the present invention, any feature of a drawing may be referenced and/or claimed in combination with any feature of any other drawing.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. The terms used herein, such as modules like display module, betting module, award module, servers, like player account server, database server, etc. are for ease in describing and illustrating features and operations of the present invention and are not to be considered limiting in any way. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the present invention illustrated and described herein is not essential, unless otherwise specified. That is, the operations described herein may be performed in any order, unless otherwise specified, and embodiments of the present invention may include additional or fewer operations than those disclosed herein. For example, it is contemplated that executing or performing a particular operation before, contemporaneously with, or after another operation is within the scope of aspects of the present invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.).

This written description uses examples to disclose the present invention, including the best mode, and also to enable any person skilled in the art to practice the present invention, including making and using any devices or systems and performing any incorporated methods. The patentable scope of the present invention is defined by the claims, and may include other examples that occur to those skilled in the art. Other aspects and features of the present invention can be obtained from a study of the drawings, the disclosure, and the appended claims. The present invention may be practiced otherwise than as specifically described within the scope of the appended claims. It should also be appreciated, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing gaming system. The system of the present invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the present invention so long as players and operators thereof are provided with useful access thereto, either through a mobile device, gaming platform, or other computing platform via a local network or global telecommunication network.

Although specific features of various embodiments of the present invention may be shown in some drawings and not in others, this is for convenience only. In accordance with the principles of the present invention, any feature of a drawing may be referenced and/or claimed in combination with any feature of any other drawing.

What is claimed is:

1. A control method of dynamically increasing a number of paylines in a reel-based wagering game, said method comprising the steps of:
providing a gaming device having a game display configured to display at least a portion of game reels of the reel-based wagering game;
providing a controller for the gaming machine programed to display, on the game display, a plurality of game reels and a multiplier reel; and
dynamically increasing, by the controller, the number of paylines per stop on the game reels on a given spin of the game reels by the multiplier reel.

2. The control method as set forth in claim 1 wherein the controller includes a random number generator and driving the multiplier wheel with the random number generator to multiply the number of paylines on each stop of the game reels.

3. The control method as set forth in claim 1 wherein each of the game reels comprise a plurality of stops per game reel.

4. The control method as set forth in claim 3 wherein the game reels comprise a first game reel, a second game reel, a third game reel, a fourth game reel, and a fifth game reel.

5. The control method as set forth in claim 4 wherein the multiplier reel has three multipliers and the first game reel has three stops, the second game reel has three stops, the third game reel has three stops, the fourth game reel has three stops, and the fifth game reel has three stops.

6. The control method as set forth in claim 5 wherein the three multipliers comprise different values to multiply the number of paylines on each of the three stops of the first game reel, the second game reel, the third game reel, the fourth game reel, and the fifth game reel.

7. A system for dynamically increasing a number of paylines in a reel-based wagering game, said system comprising:
a gaming machine having a game display configured to display at least a portion of game reels of the reel-based wagering game;
a controller programed to display, on the game display, a plurality of game reels and a multiplier reel; and
wherein the controller dynamically increases the number of paylines per stop on the game reels on a given spin of the game reels by the multiplier reel.

8. The system as set forth in claim 7 wherein the controller includes a random number generator and the random number generator drives the multiplier wheel to multiply the number of paylines on each stop of the game reels.

9. The system as set forth in claim 7 wherein each of the game reels comprise a plurality of stops per game reel.

10. The system as set forth in claim 9 wherein the game reels comprise a first game reel, a second game reel, a third game reel, a fourth game reel, and a fifth game reel.

11. The system as set forth in claim 10 wherein the multiplier reel has three multipliers and the first game reel has three stops, the second game reel has three stops, the third game reel has three stops, the fourth game reel has three stops, and the fifth game reel has three stops.

12. The system as set forth in claim 11 wherein the three multipliers comprise different values to multiply the number of paylines on each of the three stops of the first game reel, the second game reel, the third game reel, the fourth game reel, and the fifth game reel.

13. A gaming machine for dynamically increasing a number of paylines in a reel-based wagering game comprising:
a game display configured to display at least a portion of game reels of the reel-based wagering game;
a controller programed to display, on the game display, a plurality of game reels; and
wherein the controller dynamically increases the number of paylines per stop on the game reels on a given spin of the game reels by the multiplier reel.

14. The gaming machine as set forth in claim 13 wherein the controller includes a random number generator to drive the multiplier wheel to multiply the number of paylines on each stop of the game reels.

15. The gaming machine as set forth in claim 13 wherein each of the game reels comprise a plurality of stops per game reel.

16. The gaming machine as set forth in claim 15 wherein the game reels comprise a first game reel, a second game reel, a third game reel, a fourth game reel, and a fifth game reel.

17. The gaming machine as set forth in claim 16 wherein the multiplier reel has three multipliers and the first game reel has three stops, the second game reel has three stops, the third game reel has three stops, the fourth game reel has three stops, and the fifth game reel has three stops.

18. The gaming machine as set forth in claim 17 wherein the three multipliers comprise different values to multiply the number of paylines on each of the three stops of the first game reel, the second game reel, the third game reel, the fourth game reel, and the fifth game reel.
